(19) United States
(12) Patent Application Publication
(10) Pub. No.: US 2004/0255423 A1
(43) Pub. Date: Dec. 23, 2004

(54) Wiper system comprising a top plate

(76) Inventors: Michael Weiler, Karlsruhe (DE); Joachim Zimmer, Sasbach (DE)

Correspondence Address: MICHAEL BEST & FRIEDRICH, LLP, 100 E WISCONSIN AVENUE, MILWAUKEE, WI, 53202, US

(21) Appl. No.: 10/489,282

(22) PCT Filed: Sep. 26, 2002
(86) PCT No.: PCT/DE02/03636

(30) Foreign Application Priority Data
Feb. 27, 2002 (DE) 102-08-538.2

(51) Int. Cl. B60S 1/04; B60S 1/06; B60S 1/34

(52) U.S. Cl. 15/250.3; 15/250.31

(57) ABSTRACT

The invention starts with a wiper system with a mounting plate (10) made of sheet metal, which features at least one receptacle opening (38, 48) to support drive shafts (14), in which opening a pre-mounted bearing unit (12) with a bearing housing (16) is inserted, whose outer contour (24, 26) is adapted to the inner contour (42) of the receptacle opening (38, 48). It is proposed that the bearing housing (16) is a deep-drawn sheet metal part and has a cylindrical bearing sleeve (18) on which a plate-shaped flange (22) is formed.

### STATE OF THE ART

The invention starts with a wiper system with a mounting plate according to the pre-characterizing clause of claim 1.

Wiper systems with several windshield wipers for motor vehicles are fastened directly or indirectly to the vehicle body with their wiper bearings via a mounting plate. The mounting plate or a tubular mounting plate —if the wiper support also contains tubular hollow profiles—includes a motor mounting plate, which carriers a wiper drive with a wiper motor and a gear built on this. As a rule, the gear's output shaft drives other cranks via a crank and a joint rod and the other cranks are connected in a torque-proof manner with a drive shaft for each windshield wiper. The drive shafts are positioned in wiper bearings, whose bearing housings are fastened or formed on the ends of the mounting plate.

A tubular mounting plate is known from DE 19 64 266, which features at least one tubular element to support the drive shafts and the element is formed on a mounting plate tube. Opposing, outwardly pointing annular collars in the jacket surfaces of the mounting plate tube form the element. A cylindrical bearing housing made of plastic and used to support the drive shaft is inserted into the tubular element. The bearing housing is formed by a bearing sleeve and is fixed in a torque-proof manner opposite from the tubular element. To do this, the tubular element preferably has an inner contour deviating from a circular shape that is polygonal or oval and the bearing sleeve has a matching outer contour so that a positive engagement is achieved in the circumferential direction. For easier mounting, the bearing sleeve in accordance with one design has a conical contour in the longitudinal direction. The design and dimensioning of the tubular element are largely determined by the diameter of the mounting plate tube.

### ADVANTAGES OF THE INVENTION

According to the invention, the bearing housing of the wiper bearing is a deep-drawn sheet metal part, which has a cylindrical bearing sleeve on which a plate-shaped flange is formed. The bearing housing can be easily manufactured with little material expense using a simple fabrication process. It is very light and can be used for different wiper systems with different mounting plate designs and bearing arrangements as long as a suitable receptacle opening is provided. The plate-shaped flange offers a large-surface, stable support basis for the bearing housing and therefore for the drive shafts of the windshield wipers so that great driving power can also be transmitted to the windshield wipers free of vibration.

In the case of one embodiment of the invention, the bearing housing features at one end of the bearing sleeve a cuff-shaped jacket extending in the longitudinal direction, on which the flange attaches in the radial direction. Because of the cuff-shaped jacket, which represents a very rigid connection between the flange and the bearing sleeve, the radial distance of the flange from the cylindrical bearing sleeve can be bridged for one and secondly the axial position of the flange to the fore parts of the bearing housing can be defined so that the bearing unit projects more or less on either side of the mounting plate.

The outer contour of the jacket is expediently adjacent with a slight press fit to the inner contour of the receptacle opening in a manner that is free of play. In doing so, it is advantageous if the outer contour of the jacket is shaped like a truncated cone and the receptacle opening has a collar pointing in the mounting direction. The collar produces a larger fitting surface, while the slightly conical outer contour of the jacket centers the bearing housing in the receptacle opening. Especially good support is yielded if the flange is arranged approximately in a center transverse plane of the bearing sleeve between two bearings of the drive shaft.

According to a further embodiment of the invention, the outer contour of the bearing sleeve is adjacent to the inner contour of the receptacle opening. The advantage of this is that the bearing housing is supported at two locations, namely first at the bearing sleeve via the receptacle opening with its collar and secondly via the flange and the jacket, which engages at the front side of the bearing sleeve. In this connection, the collar of the receptacle opening points as a rule in the mounting direction. However, an opposite arrangement of the collar is also conceivable. In addition, the mounting plate is not weakened as much because of the receptacle opening that has a smaller diameter.

The axial extension of the jacket can determine the distance between the support [locations] of the bearing sleeve on its front side via the jacket and on its outer contour via the receptacle opening or the collar. If the bearing unit is supposed to protrude less from the mounting plate at the side of the jacket when the distance of the support locations from one another is the same, it is advantageous for the mounting plate to feature a funnel-shaped receptacle opening, which is adjacent with a cylindrical part to the bearing sleeve. The axial extension of the jacket can be shortened by the length of the funnel-shaped receptacle opening when the distance of the support locations is the same so that the installation position of the bearing unit relative to the mounting plate can be varied under the same stability conditions.

The mounting plate itself can be multiform. As a result, it can be advantageous for it to feature a fastening eye in the vicinity of the receptacle opening for the bearing unit, which is used for fastening it to a part of the vehicle body. In addition, openings to mount a wiper motor or a half-cylindrical indentation to accommodate a mounting plate tube can be provided in the vicinity of the bearing unit in the mounting plate. Finally, several identical bearing housings with a rotationally symmetrical outer contour can be arranged on the mounting plate. Because of the rotationally symmetrical design, the bearing units can be aligned easily during mounting.

### DRAWINGS

Additional advantages are yielded from the following description of the drawings. Exemplary embodiments of the invention are depicted in the drawings. The drawings, the description and the claims contain numerous features in combination. The expert will also observe individual features expediently and combine them into additional, meaningful combinations.

The drawings show:

FIG. 1A section through a bearing unit shortly before its final mounting at the end of a mounting plate.

FIG. 2A bearing unit in accordance with FIG. 1 in a mounted state.

FIG. 3A variation of FIG. 1.

FIG. 4-6 Variations of FIG. 2.

FIG. 7A variation of FIG. 5 with a fastening for a wiper motor.

FIG. 8A variation of FIG. 7 with a mounting plate tube.

FIG. 9A variation of FIG. 8 with several bearing units.

### DESCRIPTION OF THE EXEMPLARY EMBODIMENTS

In a mounting plate 10 made of sheet metal with a predominantly flat design for fastening a wiper system to a motor vehicle body, receptacle openings 38 are provided in the areas of the wiper bearings and these openings serve to accommodate pre-mounted bearing units 12. These include a drive shaft 14 or a control axis 68, which are positioned in a bearing bore hole 28 of a bearing housing 16 by means of bearings 30 and 32. The drive shaft 14 is supported axially on the fore parts of the bearings 30 and 32 via a band 36 and via a crank 34, which is fastened on the drive shaft 14.

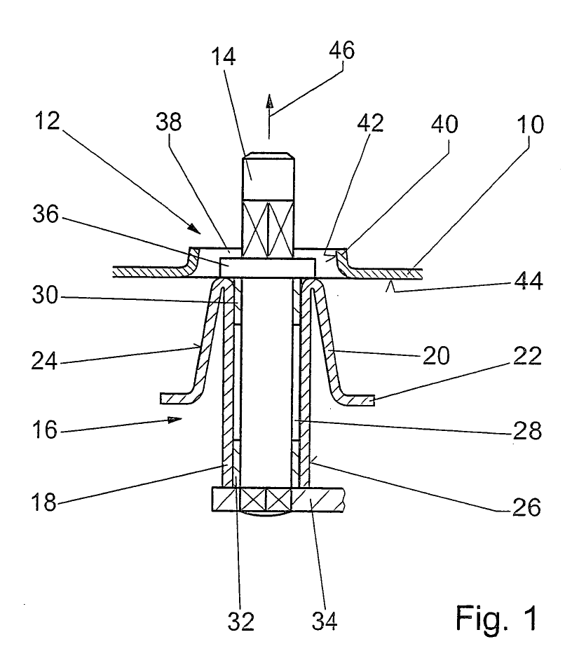

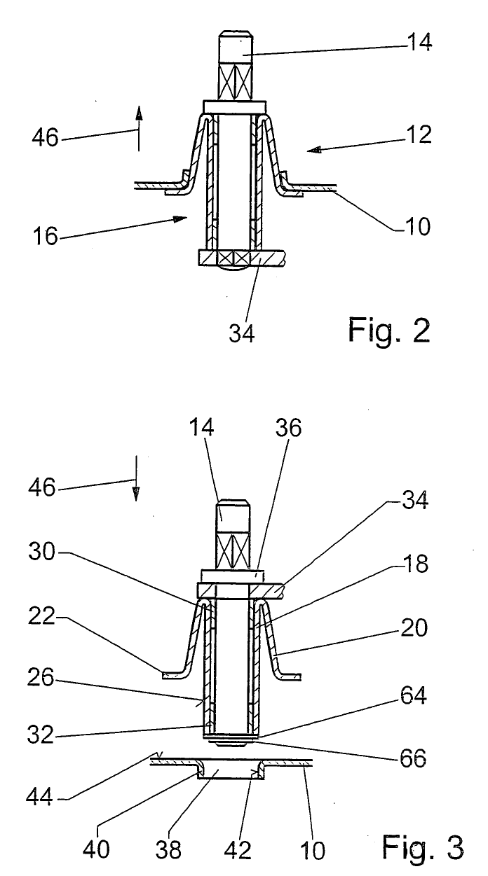

The bearing housing 16 is a deep-drawn sheet metal bent part with a bearing sleeve 18, on one end of which a cuff-shaped jacket 20 is formed, with a plate-shaped flange 22 attached radially to the outside. In the case of the embodiment according to FIG. 1, the bearing housing 16 is inserted from below into a receptacle opening 38 of the mounting plate 10. The receptacle opening 38 has a collar 40 pointing in the mounting direction 46, whose inner contour 42 is adapted to the outer contour 24 of the jacket 20 so that in a mounted state (FIG. 2) the outer contour 24 of the jacket 20 is adjacent with a slight press fit to the inner contour 42 of the collar 40, while the collar 40 touches a bearing surface 44 adjacent to the receptacle opening 38.

The outer contour 24 of the jacket 20, which can also run cylindrically in the contact area with the collar 40, runs slightly conically in the depicted exemplary embodiments, however, so that the bearing unit 12 centers itself in the mounting opening 38 during mounting. The cuff-shaped jacket 20 in connection with the collar 40 produces a radial support of the bearing unit that is dimensionally stable and free of play, while the flange 22 offers a large-surface support basis, which is especially well suited for absorbing axial forces and tilting moments.

The exemplary embodiment according to FIG. 3 differs from the exemplary embodiment according to FIGS. 1 and 2 in that the crank 34 to drive the drive shaft 14 is arranged on the output end of the bearing unit 12. As a result, the drive shaft 14 is supported axially on the front sides of the bearings 30 or 32 via the crank 34 and the band 36, on the one hand, and via a bearing disk 64 and a securing ring 66, on the other hand. In this case, the bearing unit 12 is inserted from above into the receptacle opening 38 of the mounting plate 10, whereby the inner contour 42 of the receptacle opening 38 will henceforth be adjacent to the outer contour 26 of the bearing sleeve 18 with a slight press fit. The bearing housing 16 is thereby supported radially both by the collar 40 on the bearing sleeve 18 as well as by the flange 22 via the jacket 20 in the area of the output-end front side. This results in a very stable support basis vis-à-vis tilting moments.

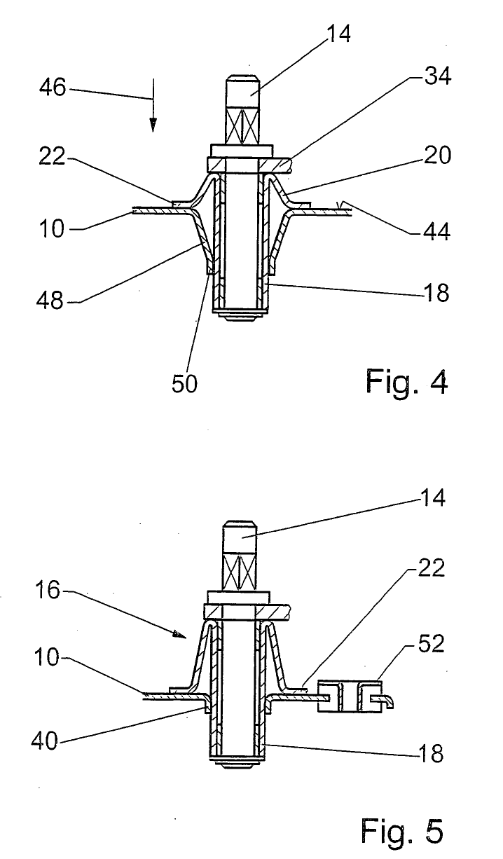

In the embodiment according to FIG. 4, the mounting plate 10 has a funnel-shaped receptacle opening 48, which is adjacent with a cylindrical area 50 to the outer contour 26 of the bearing sleeve 18 with a slight press fit. The cylindrical area 50 supports the bearing sleeve 18 in a clear distance from the bearing surface 44 of the mounting plate 10 so that the axial extension of the jacket 20 can be shorter with the same radial support basis. As a result, the bearing unit 12 can be inserted deeper into the mounting plate 10.

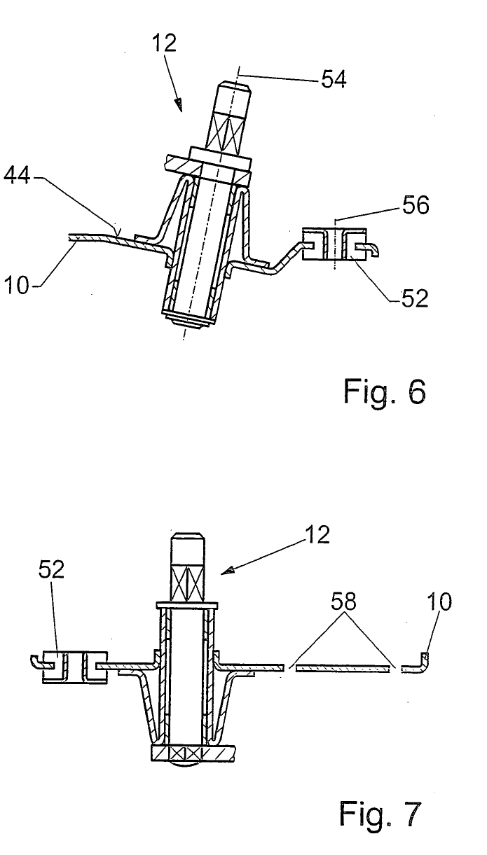

The embodiments according to FIGS. 5 through 9 show that the same bearing housing 16 can be used for various applications and correspondingly designed mounting plates 10, thereby reducing the price of manufacturing and warehousing. FIG. 5 shows a mounting plate 10 in which a fastening eye 52 is arranged in the direct vicinity of the bearing 16 and the fastening eye is used to attach the mounting plate 10 to a part of a motor vehicle (not shown). FIG. 6 shows an embodiment in which the mounting plate 10 is bent in the area of the bearing surface 44 so that a longitudinal axis 54 of the bearing unit 12 runs inclined to an axis 56 of the fastening eye 52. In the embodiment according to FIG. 7, in addition to the fastening eye 52 in the vicinity of the bearing unit 12, the mounting plate 10 also has openings 58 to accommodate a wiper motor (not shown).

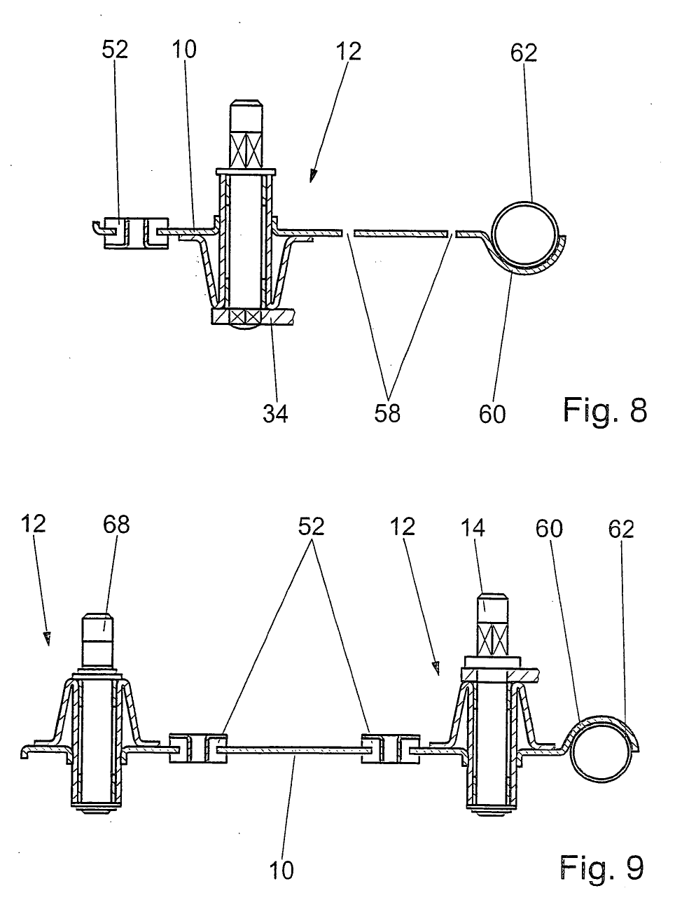

In the case of the embodiment according to FIG. 8, a half-cylindrical indentation 60 in which a mounting plate tube 62 is embedded is added to the openings 58 for the wiper motor. This can connect several mounting plates 10 for a wiper system with one another. The embodiment according to FIG. 9 shows a mounting plate 10 with several bearing units 12 that are essentially the same, like those that are used, for example, for driving a windshield wiper using a four-bar lever mechanism. The two bearing units 12 differ only in that the one accommodates a drive shaft 14 and the other a control axis 68.

1. Wiper system with a mounting plate (10) made of sheet metal, which features at least one receptacle opening (38, 48) to support drive shafts (14), in which opening a pre-mounted bearing unit (12) with a bearing housing (16) is inserted, whose outer contour (24, 26) is adapted to the inner contour (42) of the receptacle opening (38, 48), characterized in that the bearing housing (16) is a deep-drawn sheet metal part and has a cylindrical bearing sleeve (18) on which a plate-shaped flange (22) is formed.

2. Wiper system according to claim 1, characterized in that the bearing housing (16) features at one end of the bearing sleeve (18) a cuff-shaped jacket (20) extending in the longitudinal direction, on which the flange (22) attaches in the radial direction.

3. Wiper system according to claim 2, characterized in that the outer contour (24) of the jacket (20) is adjacent to the inner contour (42) of the receptacle opening (38) (FIG. 1).

4. Wiper system according to claim 1, characterized in that the outer contour (24) of the jacket (20) is shaped like a truncated cone and the receptacle opening (38) has a collar (40) pointing in the mounting direction (46).

5. Wiper system according to claim 1, characterized in that the flange (22) is arranged approximately in a center transverse plane of the bearing sleeve (18).

6. Wiper system according to claim 1, characterized in that the outer contour (26) of the bearing sleeve (18) is adjacent to the inner contour (42) of the receptacle opening (38) (FIGS. 3 through 9).

7. Wiper system according to claim 1, characterized in that the mounting plate (10) features a funnel-shaped receptacle opening (48), which is adjacent with a cylindrical area (50) to the bearing sleeve (18) (FIG. 4).

8. Wiper system according to claim 1, characterized in that a fastening eye (52) is provided in the mounting plate (10) in the vicinity of the receptacle opening (38, 48).

9. Wiper system according to claim 8, characterized in that the longitudinal axis (54) of the receptacle opening (38, 48) and bearing surfaces (44) for the bearing housing (16) that are attached to the receptacle opening (38, 48) run inclined to the axis (56) of the bearing eye (52) (FIG. 6).

10. Wiper system according to claim 1, characterized in that the mounting plate (10) features openings (58) in the vicinity of bearing unit (12) to mount a wiper motor (FIG. 7).

11. Wiper system according to claim 1, characterized in that the mounting plate (10) has a half-cylindrical indentation (60) to accommodate a mounting plate tube (62) (FIG. 8).

12. Wiper system according to claim 1, characterized in that the several identical bearing housings (16) are arranged on the mounting plate (10) (FIG. 9).

13. Wiper system according to claim 12, characterized in that bearing housings (16) with a rotationally symmetrical outer contour are arranged on the mounting plate (10).
